(19) United States
(12) Patent Application Publication
(10) Pub. No.: US 2016/0335556 A1
(43) Pub. Date: Nov. 17, 2016

(54) PREDICTION DEVICE, TERMINAL, PREDICTION METHOD, AND NON-TRANSITORY COMPUTER READABLE STORAGE MEDIUM

(71) Applicant: YAHOO JAPAN CORPORATION, Tokyo (JP)

(72) Inventor: Teruhiko TERAOKA, Tokyo (JP)

(73) Assignee: YAHOO JAPAN CORPORATION, Tokyo (JP)

(21) Appl. No.: 15/053,347

(22) Filed: Feb. 25, 2016

(30) Foreign Application Priority Data
May 13, 2015 (JP) 2015-098255

(51) Int. Cl. G06N 7/00; G06N 5/02

(52) U.S. Cl. CPC G06N 7/005; G06N 5/02

(57) ABSTRACT

A prediction device according to an embodiment includes an acquiring unit and a predicting unit. The acquiring unit acquires usage states of a plurality of terminals used by a user. The predicting unit predicts a context of the user on the basis of the usage states of the respective terminals acquired by the acquiring unit. For example, the acquiring unit acquires discrete data indicating the usage state of each of the terminals, and the predicting unit predicts the context of the user on the basis of a combination of pieces of discrete data acquired from the respective terminals.

### CROSS-REFERENCE TO RELATED APPLICATION(S)

The present application claims priority to and incorporates by reference the entire contents of Japanese Patent Application No. 2015-098255 filed in Japan on May 13, 2015.

### BACKGROUND OF THE INVENTION

1. Field of the Invention

The present invention relates to a prediction device, a terminal, a prediction method, and a non-transitory computer readable storage medium having stored therein a prediction program.

2. Description of the Related Art

A communication terminal (hereinafter, described as a “terminal”) provided with various sensors is becoming widespread. The sensors provided on the terminal convert physical phenomena into digital signals and acquire data for predicting a context of a user who owns the terminal. The terminal also accumulates usage states (an operation log or the like) of the terminal itself as pieces of data for predicting the context of the user. These pieces of the information are transmitted to a predetermined server via a network and used to analyze the context of the user. The context indicates a situation in which the user uses the terminal or a state of the user who owns the terminal.

As a technique related to the context, there is a known technique for identifying the context of the user on the basis of data detected by an acceleration sensor, a peripheral light detector, and the like mounted on the terminal (for example, Japanese National Publication of International Patent Application No. 2014-513330). Furthermore, there is a known technique for improving the accuracy of identification of the context of the user by causing a classifier to learn data acquired by the terminal (for example, Japanese National Publication of International Patent Application No. 2012-527810). Moreover, there is a known technique in which when a context of the user is defined and the defined context is observed, an application in the terminal is adjusted so as to correspond to the defined context (for example, Japanese National Publication of International Patent Application No. 2013-512641).

However, in the above-described conventional techniques, a load of recognizing the context of the user is large. As described above, the operation log of the terminal or data acquired by the sensor of the terminal may be used as a criterion for recognizing the context by the terminal. For example, the data acquired by the sensor is based on a user's behavior that is indirectly observed. Therefore, to determine the context based on the data acquired by the sensor, it is necessary to provide a variety of data, a large amount of data, and high-density data.

Specifically, to obtain data useful for determining the context, it is necessary for the user to wear the sensor (terminal) for a long time and it is necessary to perform a sophisticated data analysis on the data acquired by the sensor. For example, to recognize a context indicating that the user is walking, it is necessary to continuously move the acceleration sensor of the terminal, to continuously acquire data, and to continuously analyze the data. This indicates that a processing load of the terminal increases as compared to the normal usage state of the terminal. Furthermore, it is a burden for the user to always wear the terminal.

### SUMMARY OF THE INVENTION

It is an object of the present invention to at least partially solve the problems in the conventional technology.

A prediction device according to the present application includes an acquiring unit that acquires usage states of a plurality of terminals used by a user, and a predicting unit that predicts a context of the user on the basis of a combination of the usage states of the respective terminals acquired by the acquiring unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a prediction process according to an embodiment;

FIG. 2 is a diagram illustrating a configuration example of a prediction processing system according to the embodiment;

FIG. 3 is a diagram illustrating a configuration example of a prediction device according to the embodiment;

FIG. 4 is a diagram illustrating an example of a usage state storage unit according to the embodiment;

FIG. 5 is a diagram illustrating an example of a model storage unit according to the embodiment;

FIG. 6 is a diagram illustrating an example of a content storage unit according to the embodiment;

FIG. 7 is a first diagram for explaining an example of an analysis process performed by an analyzing unit according to the embodiment;

FIG. 8 is a second diagram for explaining the example of the analysis process performed by the analyzing unit according to the embodiment;

FIG. 9 is a first diagram for explaining an example of a prediction process performed by a predicting unit according to the embodiment;

FIG. 10 is a second diagram for explaining the prediction process performed by the predicting unit according to the embodiment;

FIG. 11 is a flowchart illustrating the flow of a generation process according to the embodiment;

FIG. 12 is a flowchart illustrating the flow of a prediction process according to the embodiment; and

FIG. 13 is a diagram illustrating an example of a hardware configuration of a computer that implements functions of the prediction device.

### DETAILED DESCRIPTION OF THE PREFERRED EMBODIMENTS

Modes (hereinafter, referred to as “embodiments”) for carrying out a prediction device, a terminal, a prediction method, and a prediction program according to the present application will be described in detail below with reference to the drawings. The prediction device, the terminal, the prediction method, and the prediction program of the present application are not limited by the embodiments. The embodiments may be combined appropriately as long as the processes do not conflict with each other. In each of the embodiments below, the same components will be denoted by the same reference numerals and symbols, and the same explanation will not be repeated.

1. Example of Prediction Process

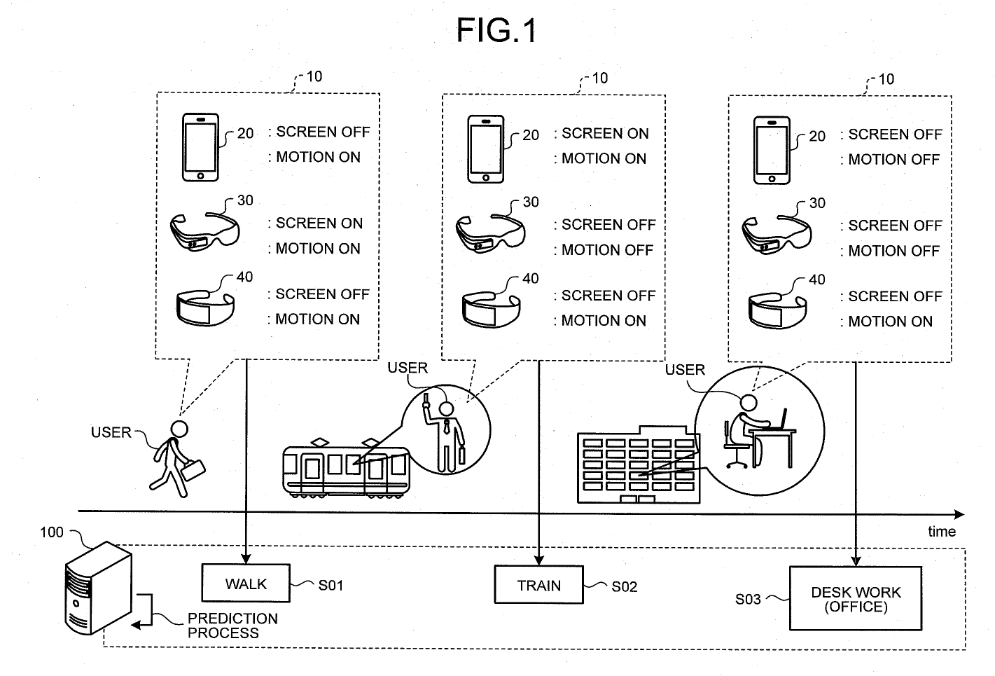

First, an example of a prediction process according to an embodiment will be described with reference to FIG. 1. FIG. 1 is a diagram illustrating an example of the prediction process according to the embodiment. FIG. 1 illustrates an example in which a prediction device 100 that performs the prediction process according to the embodiment performs a process of predicting a context of a user who owns a terminal.

The prediction device 100 is a server device that acquires information transmitted from a terminal and predicts a context. The information acquired by the prediction device 100 is data acquired by a sensor or the like inside the terminal. The data acquired by the sensor or the like inside the terminal is, for example, discrete data and represented by a simple value (for example, binary data represented by 0 and 1). The prediction device 100 acquires pieces of data from a plurality of terminals associated with a single user. The terminals associated with the user are, for example, terminals owned by the user, terminals used by the user, and the like, and may be mobile terminals or terminals installed in certain locations. Then, the prediction device 100 predicts the context of the user on the basis of a combination of the pieces of the data acquired from the terminals. In the following, an example of a process of predicting the context by the prediction device 100 will be described in accordance with the flow.

The prediction device 100 generates a prediction model corresponding to each user when predicting the context of the user. The prediction model is used to predict the context of the user on the basis of data transmitted from a terminal used by the user. The prediction model is generated based on a correlation between the data transmitted from the terminal and correct data provided by the user. The correct data is the context of the user determined by the user by him/herself. For example, if the user determines that the user is in the walking state at a certain time point, the user provides a context “walk” to the prediction device 100 as the correct data. Specifically, the prediction device 100 accepts the correct data provided by the user until a prediction model for the user as a predicting target is generated. The prediction device 100 learns a correlation between the correct data and the data acquired from the terminal, and generates a prediction model for each user. After the prediction model for the user as the predicting target is generated, the prediction device 100 inputs pieces of data of a plurality of terminals transmitted from the user in the prediction model, and predicts the context of the user corresponding to the pieces of the input data. In the following, an example of the process of predicting the context by the prediction device 100 will be described in accordance with the flow with reference to FIG. 1.

In the example illustrated in FIG. 1, the prediction device 100 acquires pieces of data from a plurality of terminals associated with a user. In the following, the terminals associated with the user are collectively described as a “user terminal 10”. The user terminal 10 includes, for example, a smartphone 20, smart glasses 30, and a smartwatch 40. If it is not necessary to distinguish the terminals from one another, the terminals including the smartphone 20 and the like may be collectively referred to as the user terminals 10. Each of the user terminals 10 acquires data to be transmitted to the prediction device 100 at predetermined time intervals or records data at a timing at which a specific event (screen ON or the like) occurs, and stores the data for a predetermined period. The user terminal 10 transmits the stored data to the prediction device 100 at a predetermined timing.

In the example in FIG. 1, data acquired by each of the user terminals 10 when the context of the user is “walk” will be described. While a user is walking, the user has less chance of viewing a screen of the smartphone 20, so that the smartphone 20 acquires a relatively large number of pieces of data “screen OFF”. Furthermore, the smartphone 20 itself is moved in accordance with the motion of the user (presence or absence of motion is determined by, for example, the fact that a built-in acceleration sensor of the smartphone 20 has observed acceleration equal to or greater than a predetermined threshold), so that the smartphone 20 acquires data “motion ON”. As the discrete data of an item “screen”, it is assumed that “0” corresponds to “screen OFF” and “1” corresponds to “screen ON”. Similarly, as the discrete data of an item “motion”, it is assumed that “0” corresponds to “motion OFF (rest)” and “1” corresponds to “motion ON (motion)”.

While the user is walking, the user has more chance of viewing a screen of the smart glasses 30. Therefore, the smart glasses 30 acquire a relatively large number of pieces of data “screen ON”. Furthermore, the smart glasses 30 itself is moved in accordance with the motion of the user, so that the smart glasses 30 acquire data “motion ON”.

While the user is walking, the user is less chance of viewing a screen of the smartwatch 40. Therefore, the smartwatch 40 acquires a relatively large number of pieces of data “screen OFF”. Furthermore, the smartwatch 40 itself is moved in accordance with the motion of the user, so that the smartwatch 40 acquires data “motion ON”.

Each of the user terminals 10 transmits the acquired data to the prediction device 100. For example, each of the user terminals 10 collectively transmits the pieces of data acquired at 10-second intervals to the prediction device 100 every one minute. Consequently, the prediction device 100 acquires a plurality of pieces of data obtained from a combination of a plurality of the user terminals 10 (the screen of the smartphone 20, the motion of the smartphone 20, the screen of the smart glasses 30, the motion of the smart glasses 30, the screen of the smartwatch 40, and the motion of the smartwatch 40). The prediction device 100 inputs the pieces of the acquired data in a prediction model corresponding to the user. In this case, the prediction device 100 inputs a relatively large number of pieces of data (0, 1, 1, 1, 0, 1) in the prediction model. The prediction device 100 predicts that the context of the user as the predicting target is “walk” on the basis of a result output from the prediction model (Step S01).

Similarly, data acquired by each of the user terminals 10 when the context of the user is “train” will be described. While the user is on the train, the user has more chance of viewing the screen of the smartphone 20, and motion of the smartphone 20 is relatively frequently observed in accordance with the user's motion of viewing the smartphone 20. Therefore, the smartphone 20 acquires pieces of data “screen ON” and “motion ON”.

Meanwhile, if the context of the user is “train”, the user has less chance of viewing the screen of the smart glasses 30 and the user is motionless on the train, so that motion of the smart glasses 30 itself is less likely to be observed. Therefore, the smart glasses 30 acquire pieces of data “screen OFF” and “motion OFF”. This indicates a tendency that, in a place such as on the train where the privacy is concerned, the smart glasses 30 is taken off or the use of the smart glasses 30 is suspended, whereas the smartphone 20 rather than the smart glasses 30 is likely to be viewed. Furthermore, while the user has less chance of viewing the screen of the smartwatch 40, motion of the smartwatch 40 itself is relatively frequently observed because of motion associated with the user's viewing of the smartphone 20 or the like. Therefore, the smartwatch 40 acquires pieces of data “screen OFF” and “motion ON”.

Each of the user terminals 10 transmits the pieces of the acquired data to the prediction device 100. Specifically, the prediction device 100 acquires a relatively large number of pieces of data (1, 1, 0, 0, 0, 1) while the user is on the train. The prediction device 100 inputs the pieces of the acquired data in the prediction model. The prediction device 100 predicts that the context of the user as the predicting target is “train” on the basis of a result output from the prediction model (Step S02).

Similarly, data acquired by each of the user terminals 10 when the context of the user is “desk work (office)” will be described. Specifically, it is assumed that the user as the processing target is engaged in a work, such as a desk work, that requires relatively less physical action in an office. While the user is doing the desk work, the smartphone 20 is usually left on a desk, so that the user has less chance of viewing the screen of the smartphone 20 and motion of the smartphone 20 itself is less likely to be observed. Therefore, the smartphone 20 acquires pieces of data “screen OFF” and “motion OFF”.

Similarly, the user has less chance of viewing the screen of the smart glasses 30 and motion of the smart glasses 30 itself is less likely to be observed. Therefore, the smart glasses 30 acquire pieces of data “screen OFF” and “motion OFF”. Furthermore, the user has less chance of viewing the screen of the smartwatch 40 but motion of the smartwatch 40 itself is relatively frequently observed because of motion associated with the user's work. Therefore, the smartwatch 40 acquires pieces of data “screen OFF” and “motion ON”.

Each of the user terminals 10 transmits the pieces of the acquired data to the prediction device 100. Specifically, the prediction device 100 acquires a relatively large number of pieces of data (0, 0, 0, 0, 0, 1) while the user is doing the desk work in the office. The prediction device 100 inputs the pieces of the acquired data in the prediction model. The prediction device 100 predicts that the context of the user as the predicting target is “desk work (office) on the basis of a result output from the prediction model (Step S03).

As described above, the prediction device 100 according to the embodiment acquires usage states of a plurality of the user terminals 10 used by a user. The prediction device 100 predicts the context of the user on the basis of a combination of the acquired usage states of the respective user terminals 10.

As described above, the prediction device 100 according to the embodiment acquires, from a plurality of the user terminals 10, discrete data (for example, binary data) which includes a screen state and a motion state of each of the user terminals 10, which is relatively easily obtained, and with which a load on the analysis is small, instead of precise data observed by a high-precision sensor. For example, the prediction device 100 employs the smartphone 20, the smart glasses 30, and the smartwatch 40 as a plurality of terminals that are used for different purposes and that have different use modes. The prediction device 100 predicts a context of a user on the basis of a combination of pieces of data acquired from the terminals. As described above, the terminals acquire different kinds of information depending on the state of the user. Therefore, by combining the usage states acquired from a plurality of the terminals, it is possible to predict the context of the user with high accuracy.

That is, the prediction device 100 according to the embodiment can predict the context of the user without attaching a plurality of sensors to the body of the user or without performing a high-precision data analysis. In other words, the prediction device 100 predicts the context without increasing processing loads on the terminals and a load on the user. Consequently, the prediction device 100 can appropriately recognize the context of the user from the acquired data while reducing a load of acquiring the data.

The prediction device 100 may perform a process of selecting any of the terminals associated with the user and distributing a predetermined content on the basis of the predicted context. For example, if the user is in the walking state, the prediction device 100 may determine that an advertisement content is not probably viewed even when the advertisement content is distributed to the smartphone 20, and may distribute the advertisement content to the smart glasses 30 instead of the smartphone 20.

In the above-described prediction process, the prediction device 100 may acquire different kinds of data, in addition to data on the screen or motion of the user terminal 10. For example, the prediction device 100 acquires time information on the time at which the data on the screen or motion of the user terminal 10 is acquired. The prediction device 100 can more accurately predict the context of the user by performing the prediction process by further using the time information.

2. Configuration of Prediction Processing System

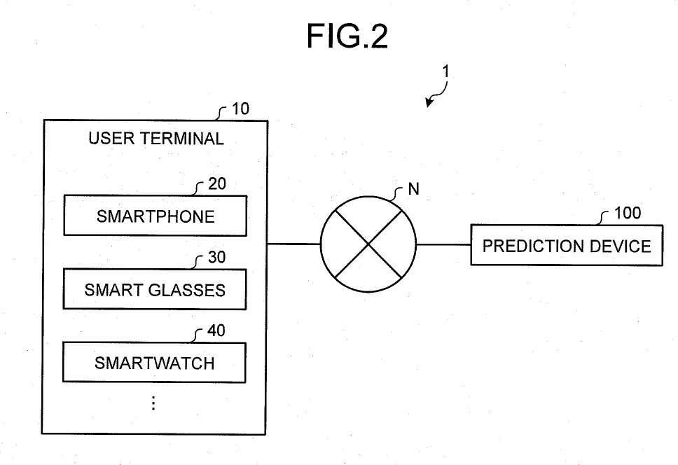

A configuration of a prediction processing system 1 including the prediction device 100 according to the embodiment will be described below with reference to FIG. 2. FIG. 2 is a diagram illustrating a configuration example of the prediction processing system 1 according to the embodiment. As illustrated in FIG. 2, the prediction processing system 1 according to the embodiment includes the user terminal 10 and the prediction device 100. The user terminal 10 includes the smartphone 20, the smart glasses 30, the smartwatch 40, and the like. These various devices are communicably connected to one another by wire or wireless via a network N.

The user terminal 10 is, for example, an information processing device, such as a desktop personal computer (PC), a notebook PC, a tablet terminal, a mobile phone including a smartphone, or a personal digital assistant (PDA). As described above, the user terminal 10 also includes a wearable device, such as the smart glasses 30 and the smartwatch 40. The user terminal 10 may include various smart devices with an information processing function. For example, the user terminal 10 may include a smart home appliance, such as a television (TV), a smart vehicle, such as a car, a drone, a home robot, and the like.

For example, the user terminal 10 switches ON/OFF of the screen in accordance with user operation or a function (implemented by an installed application or the like). Furthermore, the user terminal 10 includes various built-in sensors. For example, the user terminal 10 includes sensors for measuring various physical quantities, such as acceleration, temperature, gravity, rotation (angular velocity), illuminance, geomagnetism, pressure, proximity, humidity, and rotation vector. The user terminal 10 acquires pieces of information measured by the various sensors in accordance with the usage state of the user. The user terminal 10 transmits the pieces of the acquired information to the prediction device 100.

As described above, the prediction device 100 is a server device that predicts the context of the user on the basis of the information acquired from the user terminal 10. The prediction device 100 is also able to perform various processes based on the predicted context. For example, the prediction device 100 determines a mode of a content to be distributed or selects the user terminal 10 appropriate for the content to be distributed, on the basis of the context.

3. Configuration of Prediction Device

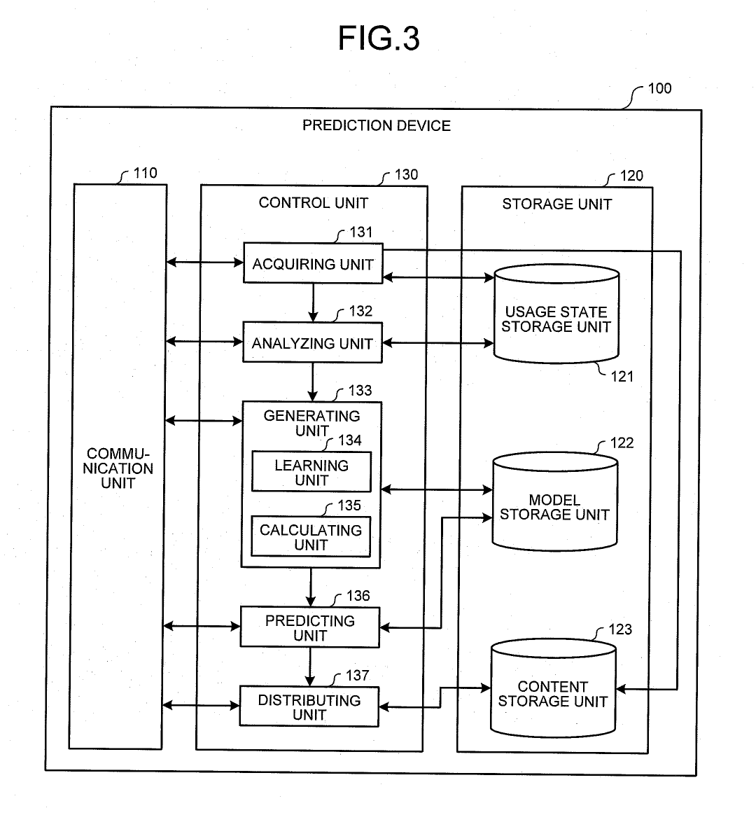

A configuration of the prediction device 100 according to the embodiment will be described below with reference to FIG. 3. FIG. 3 is a diagram illustrating a configuration example of the prediction device 100 according to the embodiment. As illustrated in FIG. 3, the prediction device 100 includes a communication unit 110, a storage unit 120, and a control unit 130. The prediction device 100 may include an input unit (for example, a keyboard, a mouse, or the like) for accepting various kinds of operation from an administrator or the like who uses the prediction device 100, or a display unit (for example, a liquid crystal display or the like) for displaying various kinds of information.

Communication Unit 110

The communication unit 110 is implemented by, for example, a network interface card (NIC) or the like. The communication unit 110 is connected to the network N by wire or wireless, and performs transmission and reception of information with the user terminal 10.

Storage Unit 120

The storage unit 120 is implemented by, for example, a semiconductor memory device, such as a random access memory (RAM) or a flash memory, or a storage device, such as a hard disk or an optical disk. The storage unit 120 includes a usage state storage unit 121, a model storage unit 122, and a content storage unit 123.

Usage State Storage Unit 121

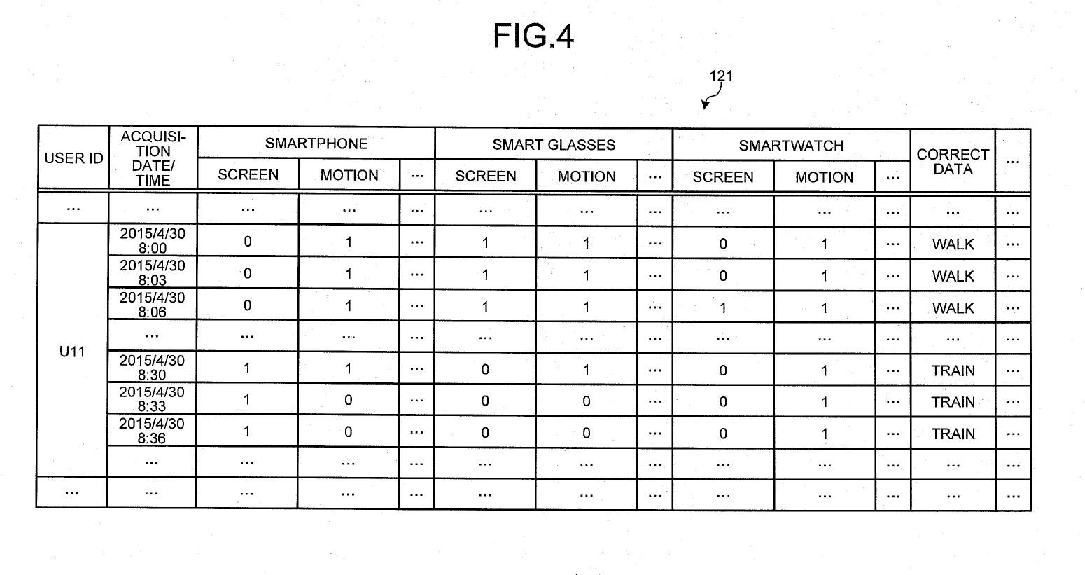

The usage state storage unit 121 stores therein information on a usage state of a context. An example of the usage state storage unit 121 according to the embodiment is illustrated in FIG. 4. FIG. 4 is a diagram illustrating the example of the usage state storage unit 121 according to the embodiment. In the example illustrated in FIG. 4, the usage state storage unit 121 includes items such as “user ID”, “acquisition date/time”, “smartphone”, “smart glasses”, “smartwatch”, and “correct data”. Furthermore, information on the usage state of each of the user terminals 10, such as “smartphone”, “smart glasses”, and “smartwatch”, includes items such as “screen” and “motion”.

The “user ID” is identification information for identifying the user or the user terminal 10 associated with the user. It is assumed that the user ID matches the reference symbol of the user who operates the user terminal 10. That is, it is assumed that the user terminal 10 identified by a user ID “U11” is a terminal device operated by a user “U11”.

The “acquisition date/time” indicates date and time at which each of the user terminals 10 acquires data. In FIG. 4, an example is illustrated in which each of the user terminals 10 acquires data every three minutes; however, the timing of acquisition is not limited to this example. That is, each of the user terminals 10 can acquire data at an arbitrary timing. For example, each of the user terminals 10 may acquire data on the user of the user terminal 10 every 10 seconds.

The “smartphone”, the “smart glasses”, and the “smartwatch” indicate pieces of information on the usage state of each terminal. For example, in the item “screen”, “1” is recorded when the state “screen ON” is observed, and “0” is recorded when the state “screen OFF” is observed. Furthermore, in the item “motion”, “1” is recorded when the state “motion ON (motion)” is observed, and “0” is recorded when the state “motion OFF (rest)” is observed.

The “correct data” indicates correct data used to learn a prediction model. The correct data is recorded when, for example, the user determines the own context and provides the determined context to the prediction device 100. The prediction device 100 need not receive the correct data after a prediction model corresponding to the user is generated.

Specifically, FIG. 4 illustrates an example of usage states acquired from a plurality of the user terminals 10 associated with the user identified by the user ID “U11”. For example, data on the usage state acquired at “April, 30 2015, 8:00” indicates that the “smartphone” is “screen OFF” and “motion ON”, the “smart glasses” is “screen ON” and “motion ON”, and the “smartwatch” is “screen OFF” and “motion ON”. Furthermore, the correct data of the information on the acquired usage state is “walk”.

Model Storage Unit 122

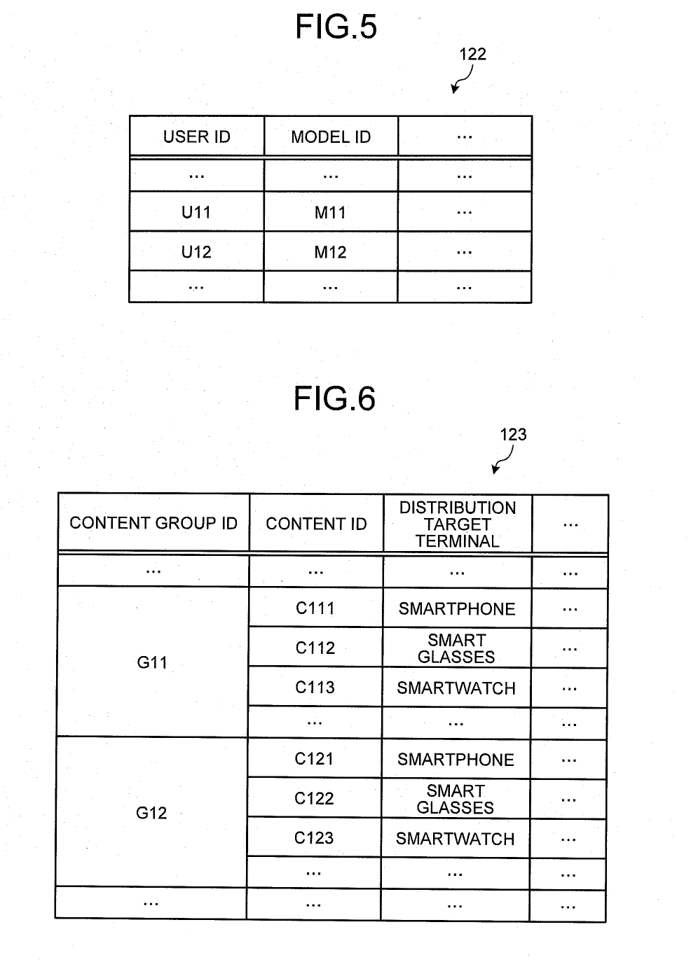

The model storage unit 122 stores therein information on a prediction model generated for each user. An example of the model storage unit 122 according to the embodiment is illustrated in FIG. 5. FIG. 5 is a diagram illustrating the example of the model storage unit 122 according to the embodiment. In the example illustrated in FIG. 5, the model storage unit 122 includes items such as “user ID” and “model ID”.

The “user ID” is identification information for identifying the user terminal 10 or the user, similarly to FIG. 4. The “model ID” is identification information for identifying the generated prediction model.

Specifically, FIG. 5 illustrates an example in which a model identified by a model ID “M11” is generated as a prediction model corresponding to the user U11 identified by the user ID “U11”.

In FIG. 5, an example is illustrated in which the user ID and the model ID are stored as a one-to-one association. Specifically, an example is illustrated in which a single prediction model is generated for a single user. However, the prediction device 100 may generate a plurality of prediction models for a single user. For example, the prediction device 100 may generate, as different prediction models, a prediction model when a single user carries three types of mobile terminals and a prediction model when the same user carries four types of mobile terminals. Furthermore, even in the case of a single user, if combinations of types of the user terminals 10 that have transmitted the acquired data are different, the prediction device 100 may generate different prediction models. Moreover, the prediction device 100 may generate different prediction models for workweek and weekend for a single user. Furthermore, the model storage unit 122 may store therein information on the process of model generation (for example, a result of a learning process performed by a learning unit 134 to be described later).

Content Storage Unit 123

The content storage unit 123 stores therein information on a content submitted from an arbitrary content providing server. An example of the content storage unit 123 according to the embodiment is illustrated in FIG. 6. FIG. 6 is a diagram illustrating the example of the content storage unit 123 according to the embodiment. As illustrated in FIG. 6, the content storage unit 123 includes items such as “content group ID”, “content ID”, and “distribution target terminal”.

The “content group ID” indicates identification information for identifying a group including a plurality of contents with a common content. For example, if a content is an advertisement content, contents in the same content group have a common advertising target.

The “content ID” indicates identification information for identifying a content. The “distribution target terminal” indicates a type of a terminal appropriate for a distribution target. For example, it is indicated that a content whose distribution target terminal is “smartphone” is a content that is generated so as to fit a display of the smartphone 20.

Specifically, in FIG. 6, it is indicated that a content group ID “G11” includes contents identified by content IDs “C111”, “C112”, and “C113”. It is also indicated that a distribution target terminal for the content identified by the content ID “C111” is a “smartphone”, a distribution target terminal for the content identified by the content ID “0112” is “smart glasses”, and a distribution target terminal for the content identified by the content ID “C113” is a “smartwatch”.

While FIG. 6 illustrates an example in which each content corresponds to a single terminal, it may be possible to include a content corresponding to a plurality of terminals. For example, a content generated with simple text data may be applicable to all types of “smartphone”, “smart glasses”, and “smartwatch” as distribution target terminals.

Data of a content to be actually distributed to the user terminal 10 may be stored in a predetermined storage server provided outside of the prediction device 100. In this case, the prediction device 100 specifies a content stored in the storage server on the basis of the content group ID or the content ID stored in the content storage unit 123. The prediction device 100 causes the storage server to distribute the specified content to the user terminal 10.

Control Unit 130

The control unit 130 is implemented by, for example, executing various programs (corresponding to an example of the prediction program) stored in an internal storage device of the prediction device 100 by a central processing unit (CPU), a micro processing unit (MPU), or the like using a RAM as a work area. Furthermore, the control unit 130 is implemented by, for example, an integrated circuit, such as an application specific integrated circuit (ASIC) or a field programmable gate array (FPGA).

As illustrated in FIG. 3, the control unit 130 includes an acquiring unit 131, an analyzing unit 132, a generating unit 133, the learning unit 134, a calculating unit 135, a predicting unit 136, and a distributing unit 137, and implements or executes functions and operations of information processing as described below. The internal configuration of the control unit 130 is not limited to the configuration illustrated in FIG. 3, and any other configuration that performs the information processing as described below is applicable. Furthermore, a connection relation between the processing units of the control unit 130 is not limited to the connection relation illustrated in FIG. 3, and any other connection relation is applicable.

Acquiring Unit 131

The acquiring unit 131 acquires usage states of a plurality of the user terminals 10 used by a user. Specifically, the acquiring unit 131 acquires usage states of the user terminals 10 (the smartphone 20, the smart glasses 30, the smartwatch 40, and the like) owned or used by the user.

Furthermore, when acquiring information, the acquiring unit 131 may acquire a usage state of at least one mobile terminal that can be carried with a user among the user terminals 10. The acquiring unit 131 can acquire motion and positional information on the user by acquiring the usage state of the mobile terminal, and therefor can easily acquire information useful for predicting the context of the user as compared to a terminal installed in a certain place.

The acquiring unit 131 may also acquire a usage state of a function of each of the user terminals 10. The function of each of the user terminals 10 is implemented by, for example, an application installed in the user terminal 10. The function of each of the user terminals 10 may be a single function or may include a plurality of functions. The above-described information on ON/OFF of the screen or motion/rest of the user terminal 10 may be acquired by the function of an application installed in the user terminal 10. In this case, the user terminal 10 acquires the usage state, such as ON/OFF of the screen and motion/rest, by a pre-installed application with a predetermined sensing function. The acquiring unit 131 acquires the usage state by receiving the usage state acquired by the user terminal 10.

The acquiring unit 131 may acquire the usage states from a plurality of the user terminals 10 at different timings. In this case, for example, the acquiring unit 131 integrates pieces of data acquired from the user terminals 10 by using acquisition date and time at which each of the user terminals 10 has acquired a piece of the data as a key, and acquires the usage state corresponding to the user associated with the user terminals 10.

Furthermore, the acquiring unit 131 acquires a predetermined content distributed to the user. For example, the acquiring unit 131 acquires a content submitted to the prediction device 100 via a terminal operated by a content submitter. Examples of the content submitter include an advertiser who submits an advertisement content. The acquiring unit 131 stores the acquired content in the content storage unit 123.

Analyzing Unit 132

The analyzing unit 132 analyzes various kinds of data acquired by the acquiring unit 131. For example, the analyzing unit 132 analyzes information on the usage state of the user terminal 10 acquired by the acquiring unit 131.

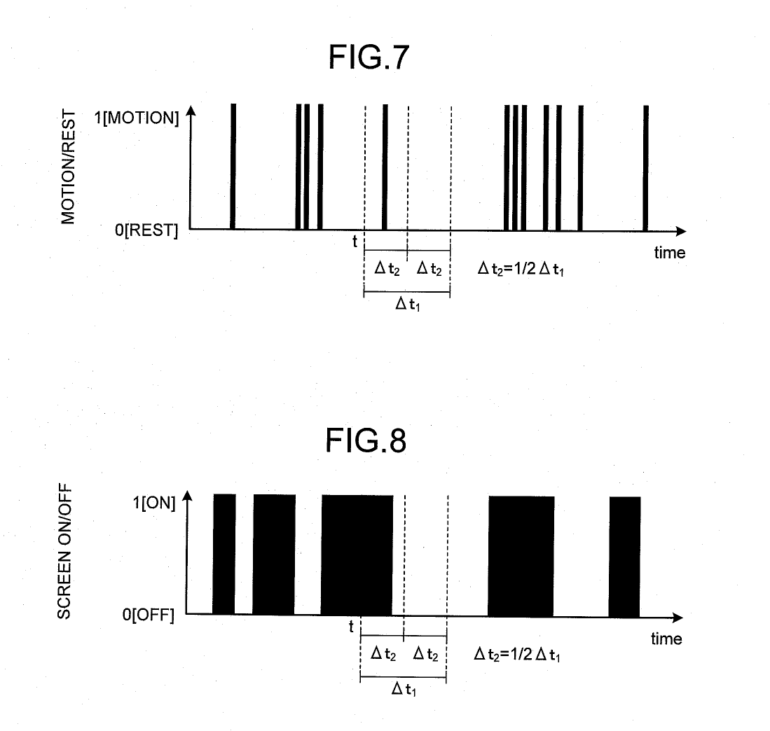

An example of an analysis process performed by the analyzing unit 132 will be described below with reference to FIG. 7. FIG. 7 is a first diagram for explaining the example of the analysis process performed by the analyzing unit 132 according to the embodiment. FIG. 7 illustrates, as an example of the usage state, data indicating whether a built-in sensor of the user terminal 10 has observed motion of the user terminal 10.

In the example illustrated in FIG. 7, it is indicated that data indicating “1” is recorded when motion of the user terminal 10 is observed, and the data indicating “1” is not recorded when motion is not observed. The analyzing unit 132 sets a predetermined observation time “Δt₁”. For example, “Δt₁” is set to the same timing as a timing at which the user terminal 10 transmits data. For example, the analyzing unit 132 sets “Δt₁” to “10 seconds”.

The analyzing unit 132 counts the number of pieces of data indicating “1” observed in “Δt₁” with respect to pieces of data transmitted by the user terminal 10 every 10 seconds. If the number of pieces of data indicating “1” observed in “Δt₁” is greater than a predetermined number, the analyzing unit 132 analyzes that data corresponding to the item “motion” of the user terminal 10 is “1” as the usage state at this time. In contrast, if the number of pieces of data indicating “1” observed in “Δt₁” is lower than the predetermined number, the analyzing unit 132 analyzes that the data corresponding to the item “motion” of the user terminal 10 is “0” as the usage state at this time.

In the above-described analysis process, the analyzing unit 132 may use “Δt₂” that is a half of “Δt₁”. For example, if more than a predetermined number of pieces of data indicating “1” are observed in each of the two “Δt₂”, the analyzing unit 132 may analyze that the data corresponding to the item “motion” is “1” in “Δt₁”. As described above, the analyzing unit 132 performs various analysis processes on the usage states transmitted from the user terminals 10, so that it is possible to acquire data in which an error of information on each of the user terminals 10 or a difference in the sensitivity performance of the sensors is absorbed. Furthermore, the analyzing unit 132 may adjust a setting of the duration indicated by “Δt₁” in order to improve the accuracy of the context prediction process. The adjustment may be performed in conjunction with processes performed by the learning unit 134 and the predicting unit 136 to be described later. For example, the analyzing unit 132 may use a method of optimizing the duration of “Δt₁” by appropriately adjusting the duration of “Δt₁” in accordance with the accuracy rate of the context predicted by the predicting unit 136, and performing a predetermined learning process on the accuracy of the context to be predicted.

Furthermore, the analyzing unit 132 may perform an analysis based on the duration of a predetermined use mode of the user terminal 10. This will be described below with reference to FIG. 8. FIG. 8 is a second diagram for explaining the example of the analysis process performed by the analyzing unit 132 according to the embodiment. FIG. 8 illustrates, as an example of the usage state, observation data indicating whether the screen of the user terminal 10 is ON.

In the example illustrated in FIG. 8, it is indicated that data indicating “1” is recorded when the screen of the user terminal 10 is ON, and the data indicating “1” is not recorded when the screen is OFF. Similarly to the example in FIG. 7, the analyzing unit 132 sets a predetermined observation time “Δt₁”.

The analyzing unit 132 measures duration of the data indicating “1” observed in “Δt₁”. If the measured duration of the data indicating “1” in “Δt₁” is longer than predetermined duration, the analyzing unit 132 analyzes that the data corresponding to the item “screen” of the user terminal 10 is “1” as the usage state at this time. In contrast, if the measured duration of the data indicating “1” in “Δt₁” is not longer than the predetermined duration, the analyzing unit 132 analyzes that the data corresponding to the item “screen” of the user terminal 10 is “0” as the usage state at this time.

Similarly to FIG. 7, the analyzing unit 132 may use “Δt₂” that is a half of “Δt₁”. For example, if the measured duration of the data indicating “1” is longer than predetermined duration in each of the two “Δt₂”, the analyzing unit 132 may analyze that the data corresponding to the item “screen” is “1” in “Δt₁”. Alternatively, when the measured duration of the data indicating “1” is longer than “Δt₂”, the analyzing unit 132 may analyze that the data corresponding to the item “screen” is “1” in “Δt₁”.

Incidentally, if the user terminal 10 has a function to perform the above-described analysis process, the analyzing unit 132 need not perform the above-described analysis process. For example, if the user terminal 10 can acquire usage state analysis data as described above by using a predetermined sensing application and can transmit the acquired data to the prediction device 100, the analyzing unit 132 may use the transmitted data as a result of the analysis process without performing the above-described analysis process.

As described above, the acquiring unit 131 acquires discrete data from each of the user terminals 10, as data indicating the usage state of each of the user terminals 10. For example, the acquiring unit 131 acquires binary data indicating the usage state of each of the user terminals 10 from each of the user terminals 10. Therefore, the analyzing unit 132 can perform a process by using data with a low processing load.

The analyzing unit 132 stores a result of the analysis on the usage state transmitted from each of the user terminals 10 in the usage state storage unit 121.

Furthermore, the analyzing unit 132 sends the result of the analysis to the generating unit 133.

Generating Unit 133

The generating unit 133 generates a prediction model for predicting the context of the user on the basis of information analyzed by the analyzing unit 132. The generating unit 133 generates a prediction model optimized for prediction of a context on the basis of a result of the learning process performed by the learning unit 134 or a result of the calculation process performed by the calculating unit 135.

Specifically, the generating unit 133 generates a prediction model, in which information on a combination of the usage states of a plurality of the user terminals 10 is input and from which the context of the user is output. Furthermore, the generating unit 133 sets a weighted value calculated by the calculating unit 135 for each of the user terminals 10, and adjusts a weight of the user terminal 10 that may give a large impact on prediction of the context of the user, thereby generating an optimized prediction model.

The generating unit 133 generates a prediction model for each user. In other words, the learning unit 134 and the calculating unit 135 to be described later respectively perform the learning process and the calculation process for each user. The generating unit 133 appropriately stores the generated prediction model and results of the learning process and the calculation process used to generate the prediction model in the model storage unit 122 in association with a processing target user.

Learning Unit 134

The learning unit 134 learns a correlation between the usage states of a plurality of the user terminals 10 acquired by the acquiring unit 131 and correct data of the context of the user. For example, the learning unit 134 performs machine learning about whether correct data of a combination of the usage states can be obtained on the basis of the information on the combination of the usage states transmitted from the respective user terminals 10.

Specifically, the learning unit 134 performs so-called supervised learning through statistical processing on data obtained from a combination of a plurality of the user terminals 10 (the screen of the smartphone 20, the motion of the smartphone 20, the screen of the smart glasses 30, the motion of the smart glasses 30, the screen of the smartwatch 40, and the motion of the smartwatch 40) and correct data on the obtained data. By repeating the above-described learning, the learning unit 13 can generate a prediction model that predicts the context of the user with high accuracy, on the basis of a combination of the usage states transmitted from the respective user terminals 10.

The learning unit 134 may perform learning by combining the usage state and the time information transmitted from the user terminal 10. A description will be given by using a combination of binary data related to the item “screen” of the smartphone 20 and the time information as an example. The learning unit 134 acquires data on the usage state, such as (the screen of the smartphone 20, t). This information is transmitted from the acquiring unit 131 or the analyzing unit 132 to the learning unit 134, for example. Here, “t” indicates arbitrary time information.

Similarly, the learning unit 134 acquires data, such as (the screen of the smartphone 20, t−k) and (the screen of the smartphone 20, t+k). Here, “k” indicates predetermined time information. The learning unit 134 learns a correlation between the data (the screen of the smartphone 20, t) and the data (the screen of the smartphone 20, t−k) or the data (the screen of the smartphone 20, t+k) in the learning process. Specifically, the learning unit 134 learns a correlation of the usage state of the user terminal 10 at a time before or after a predetermined time. In other words, the learning unit 134 performs learning for predicting a context at a time t, on the basis of data corresponding a time (t−k) or a time (t+k). As described above, the learning unit 134 can generate a prediction model for predicting a context of a user on the basis of the time information. For example, the learning unit 134 performs learning for predicting a context at the time t on the basis of data before t, that is, before a time for which prediction is to be performed (for example, after five minutes). In this case, the learning unit 134 learns the usage states of the user terminal 10 at times t−k, t−k+1, t−k+2, t−k+3, . . . (<t). Consequently, the learning unit 134 can generate a model for predicting a future context of the user.

The learning unit 134 may perform learning by using not only the above-described time information but also other kinds of information. For example, the learning unit 134 may perform learning by using day information, instead of the time information. In this case, the learning unit 134 can learn a correlation between the data acquired from the user terminal 10 and a day of the week. By including the day information in the result of the learning process, the generating unit 133 can generate a prediction model that can more accurately predict the context of the user. Furthermore, the learning unit 134 may learn a correlation between data acquired from the user terminal 10 and positional information on the user. Moreover, the learning unit 134 may perform learning by combining various kinds of information as described above.

Calculating Unit 135

The calculating unit 135 calculates a weighted value indicating an impact on prediction of a context for each of the user terminals 10, on the basis of the usage state acquired from each of the user terminals 10. Specifically, the calculating unit 135 calculates a weighted value indicating an impact on prediction of a context for each of the user terminals 10, on the basis of a result of the learning process of learning a correlation between the usage state and the correct data acquired from each of the user terminals 10.

For example, in the learning process performed by the learning unit 134, a predetermined calculation formula is used, in which correct data is placed on the left side and a parameter obtained by multiplying a coefficient indicating a weighted value and information for identifying the user terminal 10 is placed on the right side. In the calculation formula, the number of parameters placed on the right side corresponds to the number of the user terminals 10 used in the learning process. The calculating unit 135 calculates a weighted value for each of the user terminals 10 in the course of the learning process performed by the learning unit 134. The weighted value is expected to converge to an appropriate value with an increase in the calculation formulas used in the calculation.

The calculating unit 135 calculates a higher weighted value for the user terminal 10 that has more impact on prediction of the context of the user. For example, it is assumed that a processing target user always wears the smartwatch 40 in usual activities of the user and data “motion” is always observed. In this case, it is expected that the degree of contribution of the smartwatch 40 to prediction of the context of the user is low. If the learning process is performed on the user, the calculating unit 135 calculates a low weighted value for the smartwatch 40 associated with the user. In contrast, in the learning for the user, if it is learned that the correct data of the context of the user can be obtained with high accuracy on the basis of data indicating that the specific user terminal 10 is moved or the screen is ON, the calculating unit 135 calculates a high weighted value for the specific user terminal 10.

The calculating unit 135 may calculate not only the weighted value for each of the user terminals 10, but also a weighted value related to each function of the user terminal. For example, if the degree of impact of data acquired based on a specific function on prediction of a context is high, the calculating unit 135 calculates a high weighted value for the function.

The generating unit 133 generates a prediction model corresponding to each user on the basis of the learning process and the calculation process as described above. Consequently, the generating unit 133 can generate an optimized prediction model in which the user terminal 10 and data used for prediction of the context are weighted.

Predicting Unit 136

The predicting unit 136 predicts the context of the user on the basis of a combination of the usage states of the respective user terminals 10 acquired by the acquiring unit 131. Specifically, the predicting unit 136 inputs a combination of the usage states of a plurality of the user terminals 10 in a prediction model generated for each user. Then, the predicting unit 136 predicts the context of the user on the basis of a result output from the prediction model.

For example, the predicting unit 136 inputs a combination of the usage states of a plurality of the user terminals 10 in the prediction model, so that an index value (score) of a context corresponding to the input combination of the usage states is output. The score indicates the degree of probability of a context predicted by the input combination of the usage states. For example, a higher output score of a context indicates a context closer to the correct data. In other words, as the output score of the context is higher, “the probability that the user is in the context” is increased.

The predicting unit 136 may use not only the information on motion/rest or ON/OFF of the screen as described above, but also various kinds of information as the combination of the usage states of a plurality of the user terminals 10. For example, the predicting unit 136 may input, in the prediction model, various kinds of information, such as time information on a time point at which data is acquired, time information on a time before or after a time point at which data to be predicted is acquired, date/time information on a day of the week, or positional information. The predicting unit 136 can more accurately output the score by using the information learned by the prediction model generated by the generating unit 133. For example, by including the time information in the combination of the usage states of the plurality of the user terminals 10 for a prediction model that has performed learning with the time information a relatively large number of times, the predicting unit 136 can perform a prediction process with higher accuracy.

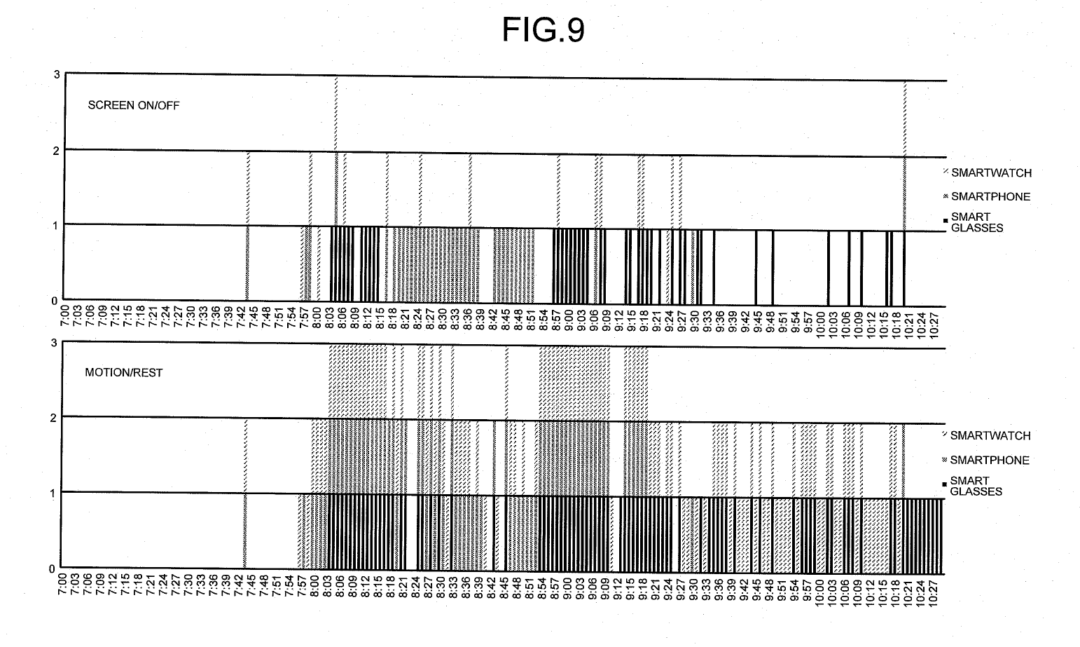

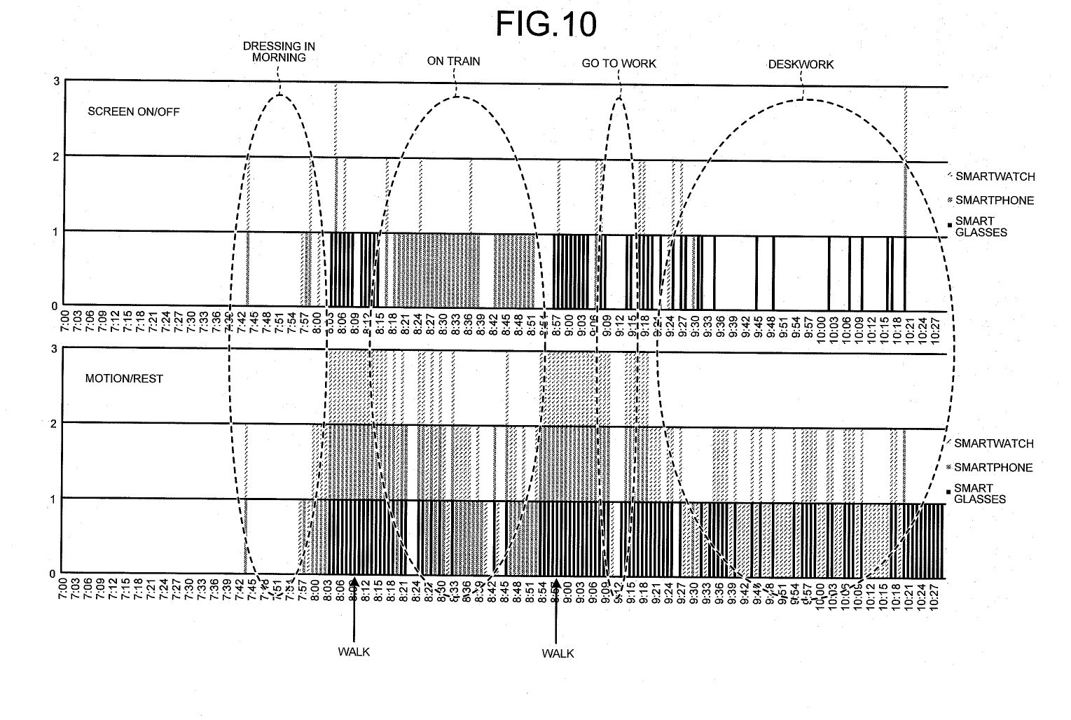

An example of the prediction process performed by the predicting unit 136 will be described below with reference to FIG. 9 and FIG. 10. FIG. 9 is a first diagram for explaining an example of the prediction process performed by the predicting unit 136 according to the embodiment. FIG. 9 illustrates an example in which pieces of data “screen ON/OFF” and “motion/rest” of the smartphone 20, the smart glasses 30, and the smartwatch 40 are illustrated as the usage states of a plurality of the user terminals 10, together with pieces of the time information. Furthermore, in FIG. 9, it is indicated that “1” is added in the upward direction of the graph when “screen ON” or “motion” is observed in the user terminals 10. In the example illustrated in FIG. 9, pieces of data acquired during a time indicated by pieces of the time information “7:00 to 10:30” on the user as a predicting target are provided.

When the pieces of the data illustrated in FIG. 9 are provided, the predicting unit 136 predicts the context of the user by including the pieces of the time information. An example of the prediction process performed by the predicting unit 136 will be described below with reference to FIG. 10. FIG. 10 is a second diagram for explaining an example of the prediction process performed by the predicting unit 136 according to the embodiment. FIG. 10 illustrates a result of a context prediction process performed by the predicting unit 136 with respect to the pieces of the data illustrated in FIG. 9.

If the prediction process is performed by using the prediction model that has performed learning including the pieces of the time information, the predicting unit 136 can output a context prediction result based on the pieces of the time information as illustrated in FIG. 10. For example, it is predicted that the user is in a context of “dressing in the morning” from a state in which the number of pieces of data “screen ON” and “motion” acquired during “7:42 to 8:00” are relatively small. Subsequently, a context “walk” is observed. Thereafter, it is predicted that the user is in a context of “on the train” from the usage state of the smartphone 20 that is frequently acquired during “8:15 to 8:50”.

In some of the usage states illustrated in FIG. 10, the accuracy of prediction of a context may be inadequate if the prediction process is performed by using only the screen information and the motion information. However, with a prediction model that has learned, as the correct data, a series of daily activities of the user such as “dressing in the morning”, “walk”, and “on the train”, in addition to the pieces of time information, it is possible to use a context at a time before or after a time point of a predicting target as a parameter of the prediction process. Consequently, the predicting unit 136 can predict the context of the user with higher accuracy.

Furthermore, if a weighted value indicating an impact on prediction of a context is calculated for each of the user terminals 10 on the basis of the usage state acquired from each of the user terminals 10, the predicting unit 136 predicts the context of the user on the basis of the weighted value calculated for each of the user terminals 10.

Moreover, if the acquiring unit 131 acquires the usage states of functions of each of the user terminals 10, the predicting unit 136 predicts the context of the user on the basis of a combination of the usage states of the functions. Then, the calculating unit 135 calculates the weighted value for each of the functions, and if a prediction model is generated by using the weighted value, the predicting unit 136 predicts the context of the user on the basis of the weighted value calculated for each of the functions.

Distributing Unit 137

The distributing unit 137 distributes a content acquired by the acquiring unit 131. Specifically, the distributing unit 137 selects any of the user terminals 10 associated with the user on the basis of the context of the user predicted by the predicting unit 136, and distributes a predetermined content to the selected user terminal.

For example, upon receiving a distribution request for a content, the distributing unit 137 refers to a result of perdition of a context of a user who is a distribution target. The distributing unit 137 selects the user terminal 10 as an appropriate distribution destination of a content on the basis of the context. The distributing unit 137 distributes a content corresponding to the selected user terminal 10 among contents belonging to the same content group.

The selection of the user terminal 10 to be an appropriate distribution destination of the content based on the context may be set in advance by the administrator or the like of the prediction device 100. For example, the administrator of the prediction device 100 can make a setting in advance such that a content corresponding to the smart glasses 30 rather than the smartphone 20 is distributed to a user whose context is “walk”.

Furthermore, the selection of the user terminal 10 to be an appropriate distribution destination of the content based on the context may be set by a predetermined learning process. For example, the distributing unit 137 randomly selects the user terminal 10 and distributes a content a predetermined number of times, independent of the context. At this time, the distributing unit 137 acquires a user's response or the like to the content. Then, the distributing unit 137 determines a distribution destination of a content corresponding to the context on the basis of the magnitude of the number of responses from the user. For example, if a large number of responses to a content is observed when the content is distributed to the specific user terminal 10 in a certain context, the distributing unit 137 distributes the content to the specific user terminal 10 in the same context next time the content is distributed. As described above, the distributing unit 137 can set the user terminal 10 as an appropriate distribution destination corresponding to the context through the predetermined learning process.

4. Flow of Process

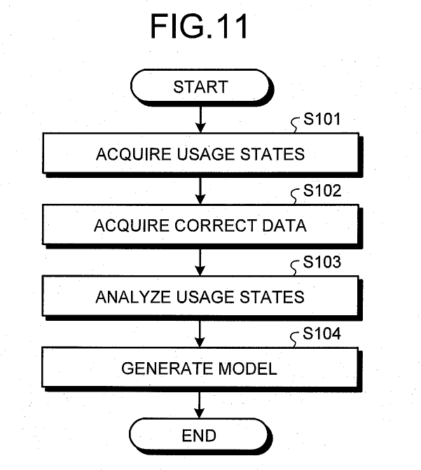

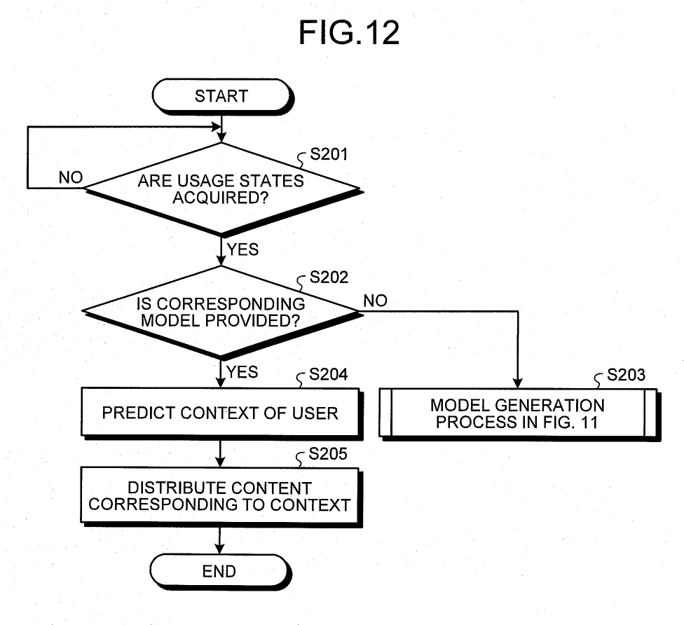

The flow of processes performed by the prediction device 100 according to the embodiment will be described below with reference to FIG. 11 and FIG. 12. First, the flow of a process of generating a prediction model for each user on the basis of the usage state of the user terminal 10 will be described below with reference to FIG. 11. FIG. 11 is a flowchart illustrating the flow of the generation process according to the embodiment.

As illustrated in FIG. 11, the acquiring unit 131 acquires the usage states of a plurality of the user terminals 10 associated with a user (Step S101). The acquiring unit 131 acquires correct data corresponding to the usage states of the user terminals 10 (Step S102).

Subsequently, the analyzing unit 132 analyzes the usage states acquired by the acquiring unit 131 (Step S103). The generating unit 133 generates a prediction model for each user on the basis of the usage states analyzed by the analyzing unit 132 (Step S104). In the generation process, the learning unit 134 appropriately performs the learning process and the calculating unit 135 appropriately performs the calculation process. The generating unit 133 stores the generated prediction model in the model storage unit 122, and ends the generation process.

The flow of a process of predicting a context of a user will be described below with reference to FIG. 12. FIG. 12 is a flowchart illustrating the flow of the prediction process according to the embodiment.

As illustrated in FIG. 12, the acquiring unit 131 determines whether the usage states of a plurality of the user terminals 10 associated with the user are acquired (Step S201). If the usage states are not acquired (NO at Step S201), the acquiring unit 131 waits until the usage states are acquired.

In contrast, if the acquiring unit 131 acquires the usage states (YES at Step S201), the predicting unit 136 determines whether a prediction model for a user corresponding to the user terminal 10 that has transmitted the usage states is provided (Step S202). If the corresponding prediction model is not provided (NO at Step S202), the predicting unit 136 does not perform the prediction process, and the process by the prediction device 100 proceeds to the model generation process illustrated in FIG. 11 (Step S203).

In contrast, if the corresponding prediction model is provided (YES at Step S202), the predicting unit 136 predicts the context of the user by using the corresponding prediction model (Step S204). Then, the distributing unit 137 distributes a content appropriate for the predicted context to the user terminal 10 (Step S205).

5. Modifications

The above-described prediction device 100 may be embodied in various different forms other than the above-described embodiment. Other embodiments of the prediction device 100 will be described below.

5-1. Generation of Prediction Model

In the above-described embodiment, an example has been described in which the usage state is acquired for each user and a prediction model corresponding to the user is generated. However, when generating a prediction model for a specific user, the prediction device 100 may generate a prediction model by using a prediction model generated for a different user.

It is assumed that the prediction device 100 has generated a large number of prediction models for users each having three types of terminals such as the smartphone 20, the smart glasses 30, and the smartwatch 40. For example, the prediction device 100 generates prediction models for a thousand of users each having the three types of terminals such as the smartphone 20, the smart glasses 30, and the smartwatch 40. Subsequently, when performing a process of predicting a context of a user who has three types of terminals such as the smartphone 20, the smart glasses 30, and the smartwatch 40 and for whom a prediction model has not been generated, the prediction device 100 generates a prediction model for the user as a new processing target, on the basis of the prediction models already generated for a thousand of users.

Consequently, the prediction device 100 can predict a context of a user as a new processing target by using a prediction model with a certain reliability, without acquiring the correct data from the user as the new processing target. Specifically, the prediction device 100 can flexibly perform a prediction process by applying an already-generated prediction model to a different user, in addition to generating a prediction model for a user for which the usage state is acquired.

5-2. Weighting

In the above-described embodiment, an example has been described in which the prediction device 100 calculates a weighted value of the user terminal 10 or each function of the user terminal 10. The prediction device 100 may calculate a weighted value for a combination of the user terminals 10 or a weighted value for a combination of the functions of the user terminal 10.

For example, the prediction device 100 calculates a weighted value related to a combination of the usage states acquired from the smartphone 20 and the smart glasses 30. Consequently, the prediction device 100 can calculate the degree of impact of the combination of the usage states of the smartphone 20 and the smart glasses 30 on prediction of a context. Furthermore, the prediction device 100 can calculate a weighted value related to a parameter formed of various combinations, such as a combination of a function of the user terminal 10 and other functions or a combination of a function of the user terminal 10 and a function of the different user terminal 10, in addition to a combination of the user terminals 10. Consequently, it is possible to generate a prediction model that reflects an impact of a combination of a plurality of terminals rather than a single terminal on the prediction process. Therefore, the prediction device 100 can predict the context of the user with higher accuracy.

5-3. Usage

In the above-described embodiment, an example has been described in which the prediction device 100 acquires, as the usage state of the user terminal 10, information on ON/OFF of the screen, a motion/rest state, and the like. However, the prediction device 100 may acquire a different kind of information.

For example, the prediction device 100 may acquire a state of a power supply of the user terminal 10. Specifically, the prediction device 100 acquires a usage state indicating a time when the power supply of the user terminal 10 is turned on and a time when the power supply is turned off. Furthermore, the prediction device 100 may appropriately acquire information corresponding to various sensors included in the user terminal 10. For example, the prediction device 100 may acquire various kinds of information, such as temperature and humidity of a place where the user terminal 10 is placed, or positional information.

5-4. Acquisition of Usage State

In the above-described embodiment, an example has been described in which the prediction device 100 acquires usage states of a plurality of the user terminals 10. However, in a certain case, the prediction device 100 may select data to be used by acquiring only the usage state of the specific user terminal 10 or by using only the usage state of the specific user terminal 10 in the prediction process.

Specifically, in some cases, the user terminal 10 that is important for prediction of a context of a user as a processing target may be determined with the progress of learning by the prediction device 100. In other words, in some cases, the weighted value of the specific user terminal 10 may be relatively increased in the prediction model corresponding to the user.

In this case, the prediction device 100 may perform adjustment to acquire the usage states from some of the user terminals 10 whose weighted values are relatively high among the user terminals 10 associated with the user, but not to acquire the usage states from some of the user terminals 10 whose weighted values are relatively low. Consequently, the prediction device 100 can reduce the amount of data to be processed without reducing the prediction accuracy. Therefore, it is possible to efficiently perform the prediction process.

5-5. Distribution of Content

In the above-described embodiment, an example has been described in which the prediction device 100 distributes a content corresponding to a predicted context. The prediction device 100 may distribute not only the content corresponding to the predicted context, but also a content corresponding to a context expected to be obtained at a time after the predicted context.

Specifically, in some cases, the prediction device 100 may be able to predict a context expected to be obtained at a time after the predicted context of the user, with the progress of learning by the prediction device 100. For example, if a prediction model including the time information and the day information is learned, the prediction device 100 can predict not only a context at a timing at which the user terminal 10 acquires the usage state, but also a context at a future time with certain accuracy, with respect to a user as a processing target.

In this case, the prediction device 100 distributes a content corresponding to a context expected to be obtained at a time after the predicted context. For example, if it is possible to predict that a user “on the train” will be in the context “walk” after a few minutes, the prediction device 100 can perform adjustment to distribute a content corresponding to the smart glasses 30 rather than the smartphone 20. As described above, the prediction device 100 can distribute a content or the like at a more appropriate timing by performing the prediction process on a future context of the user, so that it is possible to distribute a content with a high appeal effect.

5-6. Correct Data

In the above-described embodiment, an example has been described in which the prediction device 100 acquires the context of the user determined by the user by him/herself as the correct data. The prediction device 100 may acquire, as the correct data, not only the context determined by the user, but also a context determined by a predetermined device.

For example, the prediction device 100 may acquire, as the correct data, a context acquired from a dedicated device or a dedicated application that determines a content. As one example, the prediction device 100 can acquire, as the correct data in the learning step, a context determined by a function of an application program interface (API) that is provided in the smartphone 20 and that can determine a state of user's behavior, such as walk, rest, running, or transportation being used.

5-7. Prediction Device

In the above-described embodiment, an example has been described in which the prediction device 100 predicts the context of the user on the basis of the information transmitted from the user terminal 10. The user context process performed by the prediction device 100 in the embodiment may be performed by the user terminal 10.

In this case, the user terminal 10 that performs the prediction process includes processing units, such as the control unit 130, included in the prediction device 100 of the above-described embodiment. Then, the user terminal 10 aggregates the usage state acquired by the user terminal 10 or the usage states acquired by the other user terminals 10, and performs the process of predicting the context of the user. As described above, the user context process does not necessarily use a server device such as the prediction device 100, but may be realized by a configuration in which the single user terminal 10 is used as a base device. For example, if the smartphone 20 is used as a base device, it may be possible to perform the process of predicting the context by using the smart glasses 30, the smartwatch 40, other activity-amount measures, a certain audio device, and the like. The smartphone 20 that performs the prediction process does not necessarily have to acquire the usage state of the user by itself, but may function as a prediction device that performs the prediction process by using the usage state acquired from the smart glasses 30, the smartwatch 40, or the like. Furthermore, the above-described process may be implemented by a plurality of the user terminals 10. For example, the above-described process may be performed such that one of the two user terminals 10 includes the acquiring unit, the other one of the user terminals 10 includes the predicting unit, the one of the user terminals 10 performs the process of acquiring the usage state of the user, and the other one of the user terminals 10 performs the process of predicting the context of the user terminal 10.

6. Hardware Configuration

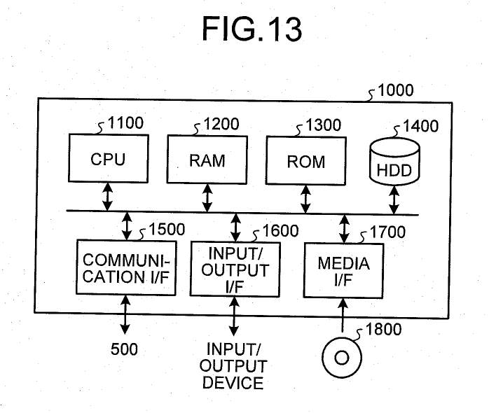

The prediction device 100 according to the above-described embodiment is implemented by, for example, a computer 1000 with a configuration as illustrated in FIG. 13. In the following, a description will be given by using the prediction device 100 as an example. FIG. 13 is a diagram illustrating an example of a hardware configuration of the computer 1000 that implements the functions of the prediction device 100. The computer 1000 includes a CPU 1100, a RAM 1200, a ROM 1300, an HDD 1400, a communication interface (I/F) 1500, an input/output I/F 1600, and a media I/F 1700.

The CPU 1100 operates based on a program stored in the ROM 1300 or the HDD 1400, and controls each of units. The ROM 1300 stores therein a boot program executed by the CPU 1100 when the computer 1000 is activated, a program that depends on the hardware of the computer 1000, and the like.

The HDD 1400 stores therein a program executed by the CPU 1100, data used by the program, and the like. The communication I/F 1500 receives data from other devices via a communication network 500 (corresponding to the network N illustrated in FIG. 2), sends the data to the CPU 1100, and transmits data generated by the CPU 1100 to other devices via the communication network 500.

The CPU 1100 controls an output device, such as a display or a printer, and an input device, such as a keyboard or a mouse, via the input/output I/F 1600. The CPU 1100 acquires data from the input device via the input/output I/F 1600. The CPU 1100 outputs generated data to the output device via the input/output I/F 1600.

The media I/F 1700 reads a program or data stored in a recording medium 1800, and provides the program or the data to the CPU 1100 via the RAM 1200. The CPU 1100 loads the program onto the RAM 1200 from the recording medium 1800 via the media I/F 1700, and executes the loaded program. The recording medium 1800 may be, for example, an optical recording medium such as a digital versatile disk (DVD) or a phase change rewritable disk (PD), a magneto-optical recording medium such as a magneto-optical disk (MO), a tape medium, a magnetic recording medium, a semiconductor memory, or the like.

For example, when the computer 1000 functions as the prediction device 100 according to the embodiment, the CPU 1100 of the computer 1000 implements the functions of the control unit 130 by executing the program loaded on the RAM 1200. Furthermore, the HDD 1400 stores therein data stored in the storage unit 120. While the CPU 1100 of the computer 1000 reads the program from the recording medium 1800 and executes the program, the program may be acquired from other devices via the communication network 500 as another example.

7. Others

Of the processes described in the embodiment, all or part of a process described as being performed automatically may also be performed manually.

Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in the drawings are not limited to the information illustrated in the drawings.

The components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions. For example, the analyzing unit 132 and the learning unit 134 illustrated in FIG. 3 may be integrated with each other. Furthermore, for example, the information stored in the storage unit 120 may be stored in an external storage device via the network N.

Moreover, in the above-described embodiment, an example has been described in which, for example, the prediction device 100 performs the prediction process of predicting a context and the distribution process of distributing a content. However, the above-described prediction device 100 may be separated into a prediction device 200 that performs the prediction process and a distribution device 300 that performs the distribution process. In this case, the prediction device 200 includes the acquiring unit 131, the analyzing unit 132, the learning unit 134, and the predicting unit 136. In addition, the distribution device 300 includes the distributing unit 137. In this case, the processes performed by the prediction device 100 according to the embodiment are implemented by the prediction processing system 1 including the prediction device 200 and the distribution device 300.

Furthermore, the embodiments and the modifications described above may be combined appropriately as long as the processes do not conflict with each other.

8. Effects

As described above, the prediction device 100 according to the embodiment includes the acquiring unit 131 and the predicting unit 136. The acquiring unit 131 acquires usage states of a plurality of the user terminals 10 used by a user. The predicting unit 136 predicts a context of the user based on a combination of the usage states of the respective user terminals 10 acquired by the acquiring unit 131.

As described above, the prediction device 100 according to the embodiment predicts the context of the user by combining the usage states of a plurality of the user terminals 10. Therefore, the prediction device 100 can recognize the context of the user with high accuracy on the basis of normal use modes of the user terminals 10, independent of a function of direct context awareness (a special sensor, a complex program for recognizing a context, or the like). Consequently, the prediction device 100 can reduce loads on the user terminal 10 and the user for recognizing the context.

Furthermore, the acquiring unit 131 acquires a usage state of at least one portable mobile terminal that can be carried with the user among the user terminals 10. The predicting unit 136 predicts the context of the user on the basis of a combination of the usage states of the user terminals 10 including the portable mobile terminal.

As described above, the prediction device 100 according to the embodiment acquires the usage state of a so-called mobile terminal, so that it is possible to acquire motion of the user or positional information on the user. Consequently, the prediction device 100 can predict the context of the user with higher accuracy as compared to the user terminal 10 that is installed in a certain place in a normal mode.

Moreover, the acquiring unit 131 acquires usage states of functions of the respective user terminals 10. The predicting unit 136 predicts the context of the user on the basis of a combination of the usage states of the respective functions acquired by the acquiring unit 131.

As described above, the prediction device 100 according to the embodiment can acquire, as one mode of the usage state of the user terminal 10, the usage state of a function of the user terminal 10 (for example, the function implemented by an application or the like installed in the user terminal 10). For example, the prediction device 100 can predict the context of the user on the basis of information transmitted from a sensing application that is installed in the user terminal 10 and that stores behavior of the user. Consequently, the prediction device 100 can combine a number of pieces of information, so that it is possible to predict the context of the user with high accuracy.

Furthermore, the prediction device 100 according to the embodiment further includes the calculating unit 135 that calculates a weighted value indicating an impact on prediction of a context for each of the user terminals 10, on the basis of the usage states acquired from the respective user terminals 10. The predicting unit 136 predicts the context of the user on the basis of the weighted values of the respective user terminals 10 calculated by the calculating unit 135.

As described above, the prediction device 100 according to the embodiment can determine the user terminal 10 that is important for performing the prediction process and can predict the context of the user. For example, the prediction device 100 predicts the context of the user by using a prediction model optimized by weighting, so that it is possible to further improve the prediction accuracy.

Moreover, the acquiring unit 131 acquires usage states of functions of the respective user terminals 10. The calculating unit 135 calculates a weighted value indicating an impact on prediction of a context for each of the functions. The predicting unit 136 predicts the context of the user on the basis of the weighted values of the respective functions calculated by the calculating unit 135.

As described above, the prediction device 100 according to the embodiment can calculate weighting of the functions of the user terminals 10. Consequently, the prediction device 100 can improve the prediction accuracy and improve the efficiency of the prediction process by, for example, avoiding acquisition of the usage state of a function with a low weighted value.

Furthermore, the acquiring unit 131 acquires discrete data indicating the usage state of each of the user terminals 10. The predicting unit 136 predicts the context of the user on the basis of a combination of pieces of the discrete data acquired from the respective user terminals 10.

Specifically, the acquiring unit 131 acquires binary data indicating the usage state of each of the user terminals 10. The predicting unit 136 predicts the context of the user on the basis of a combination of pieces of the binary data acquired from the respective user terminals 10.

As described above, the prediction device 100 according to the embodiment acquires discrete data, such as the screen state or the motion state of the user terminal 10, which is relatively easily obtained and with which a load is less likely to be applied at the time of analysis. Consequently, it is possible to reduce processing loads on the user terminal 10 that acquires data and the prediction device 100 that performs the prediction process.

Moreover, the prediction device 100 according to the embodiment further includes the distributing unit 137 that selects any of the user terminals 10 and distributes a content to the selected user terminal 10 on the basis of the context of the user predicted by the predicting unit 136.

As described above, the prediction device 100 according to the embodiment selects the user terminal 10 and distributes a content in accordance with a context. Consequently, the prediction device 100 can distribute a content expected to achieve a high appeal effect. Furthermore, the user can easily acquire information included in the content because the content is distributed to the user terminal 10 appropriate for the context among the user terminals 10.

Furthermore, the user terminal 10, which is the user terminal 10 according to the embodiment and one of the user terminals 10 used by a user, includes an acquiring unit (corresponding to the acquiring unit 131 of the prediction device 100), and a predicting unit (corresponding to the predicting unit 136 of the prediction device 100). The acquiring unit configured to perform the prediction process in the user terminal 10 acquires usage states of a plurality of the user terminals 10 used by the user. The predicting unit configured to perform the prediction process in the user terminal 10 predicts a context of the user on the basis of a combination of the usage states of the respective user terminals 10 acquired by the acquiring unit.

As described above, the user terminal 10 according to the embodiment can perform the process of predicting the context of the user by using information acquired by itself or acquired from the other user terminals 10, without transmitting information to the server device or the like. Consequently, the user terminal 10 can predict the context of the user with high accuracy without communicating with the server device over the network. The process may be performed by a plurality of the user terminals 10.

Furthermore, “a unit” recited in the claims may be replaced with “a section, a module, or a means” or “a circuit”. For example, the acquiring unit may be replaced with an acquiring means or an acquiring circuit.

According to an embodiment, it is possible to reduce a load of acquiring data and to appropriately recognize a context of a user from the acquired data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A prediction device comprising:
an acquiring unit that acquires usage states of a plurality of terminals used by a user; and
a predicting unit that predicts a context of the user on the basis of a combination of the usage states of the respective terminals acquired by the acquiring unit.

2. The prediction device according to claim 1, wherein
the acquiring unit acquires a usage state of at least one portable mobile terminal that can be carried with the user among the terminals, and
the predicting unit predicts the context of the user on the basis of a combination of the usage states of the terminals including the portable mobile terminal.

3. The prediction device according to claim 1, wherein
the acquiring unit acquires usage states of functions of the respective terminals, and
the predicting unit predicts the context of the user on the basis of a combination of the usage states of the respective functions acquired by the acquiring unit.

4. The prediction device according to claim 1, further comprising:
a calculating unit that calculates a weighted value indicating an impact on prediction of a context for each of the terminals on the basis of the usage states acquired from the respective terminals, wherein
the predicting unit predicts the context of the user on the basis of the weighted values of the respective terminals calculated by the calculating unit.

5. The prediction device according to claim 4, wherein
the acquiring unit acquires usage states of functions of the respective terminals,
the calculating unit calculates a weighted value indicating an impact on prediction of a context for each of the functions, and
the predicting unit predicts the context of the user on the basis of the weighted values of the respective functions calculated by the calculating unit.

6. The prediction device according to claim 1, wherein
the acquiring unit acquires discrete data indicating the usage state of each of the terminals, and
the predicting unit predicts the context of the user on the basis of a combination of pieces of the discrete data acquired from the respective terminals.

7. The prediction device according to claim 1, wherein
the acquiring unit acquires binary data indicating the usage state of each of the terminals, and
the predicting unit predicts the context of the user on the basis of a combination of pieces of the binary data acquired from the respective terminals.

8. The prediction device according to claim 1, further comprising:
a distributing unit that selects any of the terminals and distributes a content to the selected terminal on the basis of the context of the user predicted by the predicting unit.

9. A terminal that is one of terminals used by a user, the terminal comprising:
an acquiring unit that acquires usage states of a plurality of terminals; and
a predicting unit that predicts a context of the user on the basis of a combination of the usage states of the respective terminals acquired by the acquiring unit.

10. A prediction method implemented by a terminal that is one of terminals used by a user, comprising:
acquiring usage states of a plurality of terminals used by a user; and
predicting a context of the user on the basis of a combination of the usage states of the respective terminals acquired at the acquiring.

11. A prediction method implemented by a computer, comprising:
acquiring usage states of a plurality of terminals used by a user; and
predicting a context of the user on the basis of a combination of the usage states of the respective terminals acquired at the acquiring.

12. A non-transitory computer readable storage medium having stored therein a prediction program causing a computer to execute a process comprising:
acquiring usage states of a plurality of terminals used by a user; and
predicting a context of the user on the basis of a combination of the usage states of the respective terminals acquired at the acquiring.
